(19) United States
(12) Patent Application Publication
(10) Pub. No.: US 2016/0092795 A1
(43) Pub. Date: Mar. 31, 2016

(54) METHODS AND SYSTEMS FOR CONFIGURING RESERVATION SPACE OF VENUES

(71) Applicant: EVENTFORTE, INC., SAN JOSE, CA (US)

(72) Inventors: Ankit GUPTA, LOS ALTOS HILLS, CA (US); Tittu Thomas NELLIMOOTTIL, LOS ANGELES, CA (US)

(21) Appl. No.: 14/496,662

(22) Filed: Sep. 25, 2014

(51) Int. Cl. G06Q 10/02

(52) U.S. Cl. CPC G06Q 10/02

(57) ABSTRACT

Novel methods and systems for venue space reservation and configuration are disclosed. A venue can provide a list of options of space for use, while an organizer can provide constraints. An optimization is then carried out to find a suitable selection within the constraints and configure the space to meet the constraints of the organizer.

### CROSS REFERENCE TO RELATED APPLICATIONS

The present application may be related to U.S. patent application Ser. No. 14/279,247 filed on May 15, 2014, titled “METHODS AND SYSTEMS FOR IMPROVING SATISFACTION AND DETERMINING ITEM SELECTION AND ASSIGNMENT FOR A GROUP OF USERS” (Attorney Docket No. P1453-US) which claims priority to U.S. Provisional Patent Application No. 61/949,856 filed on Mar. 7, 2014; and may also be related to U.S. patent application Ser. No. 14/279,221 filed on May 15, 2014, titled “METHODS AND SYSTEMS FOR SECURING VENUE RENTAL AND OPTIMIZING EVENT MANAGEMENT” (Attorney Docket No. P1454-US) which claims priority to U.S. Provisional Patent Application No. 61/949,825 filed on Mar. 7, 2014; the disclosures of which are incorporated by reference herein.

### TECHNICAL FIELD

The present disclosure relates to venue management. More particularly, it relates to methods and systems for selecting and configuring venue space for venues given organizer specifications and venue space requests.

### SUMMARY

Conventionally in venue rentals, a prospective organizer will contract a rental space, for a fixed rental period, and for a predetermined cost. Venue selection is ordinarily done without consideration of venue utility or the subsequent addition or requests of other prospective organizers. This current situation leads to loss of partial utility and potential of venue spaces.

The venue conventionally arranges or suggests venue spaces based on their intuitive interpretation of the best utility of their various venue spaces.

Given the currently increasing year-to-year demand for venue rentals, for example, but not limited to, hotel venues, and the limitations in the prior approaches, an approach for renting to organizers that increases venue utility from the limitations in conventional venue rental models is preferred. Specifically, an approach for renting listed venues to organizers that takes into consideration current and future requests, as well as into consideration, the optimal configurations of allotments of space given organizer specifications is desired. There is a further need for an approach that incorporates past organizer behavior and preferences into the initial listed venue selection and optimized venue utility decisions.

The present disclosure relates to a computer-implemented approach for venue space configuration, whereby the customers (“organizers”) who wish to secure a venue decide what venue to rent using a specific set of organizer requirements combined with venue related data and organizer preferences, explicitly stated and/or implied, which thereby influence venue rental decisions and space configurations.

According to a first aspect, method for configuring a space within a venue for an event for an organizer via a computerized process is described, said method comprising: entering a data describing the space into a computer system; transforming, by the computer system, the data into a simplified data structure; gathering requirements for a group within the space into the computer system; matching, by the computer system, the requirements to roomlets within the venue; selecting, by the computer system, a set of roomlets to assign to the group that both match the requirements and provide at least one feasible pathway to at least one exterior access; changing the reservation state of the set of roomlets based on the selecting; and generating, by the computer system, a report of the selecting.

According to a second aspect, a method for configuring a space within a venue via a computerized process is described, said method comprising: establishing a roomlet within the space as having a reservation state of free for use; for a first tier of booking: if the roomlet is assigned to an organizer, changing the reservation state from free for use to tentatively booked; if the roomlet is confirmed to the organizer, changing the reservation state from tentatively booked to confirmed; for a second tier of booking, if the roomlet is assigned to the organizer, changing the reservation state from free for use to confirmed; and for either tier of booking, changing the reservation state of the roomlet to blocked if assignment of said roomlet would prevent any viable pathway to an exterior access from existing; wherein the reservation state can return to free for use from tentatively booked at any time, but cannot return to free from use from confirmed until after the roomlet is used or until a cancellation of a reservation to the venue.

According to a third aspect, a method for configuring space within a venue for a plurality of events for corresponding organizers via a computerized process is described, said method comprising: entering a data describing the space into a computer system; transforming, by the computer system, the data into a simplified data structure; gathering requirements for groups corresponding to the organizers into the computer system; matching, by the computer system, the requirements to roomlets within the space; selecting for each organizer, by the computer system, sets of the roomlets within the venue to assign to each group that matches the requirements and provides at least one feasible pathway to at least one exterior access; changing the reservation states of the sets of the roomlets based on the selecting; gathering new requirements for a new group corresponding to a new organizer into the computers system; re-matching, by the computer system, the new requirements to the roomlets within the space; re-selecting, by the computer system, a set of the roomlets that matches the new requirements and provides at least one feasible pathway to at least one exterior access; changing at least one of the reservation states of the sets of the roomlets and changing the reservation states of the set of the roomlets based on the re-selecting; and generating, by the computer system, a report of the re-selecting.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 is a flow diagram depicting arena creation according to the present disclosure.

FIG. 2 is a block diagram depicting sound transmission over multiple floors.

FIG. 3 is a block diagram depicting the conversion of a multiple-floor arena into a region adjacency graph.

FIGS. 4-A & 4-B are sets of block diagrams showing various exemplary allocations and validity according to the present disclosure.

FIG. 5 is a diagram depicting an approach for venue communication over a network to organizers and improved venue allocation for said venue and organizer over the network according to an embodiment of the disclosure.

FIG. 6 is a diagram depicting an approach for communication according to an embodiment of the disclosure.

FIG. 7 is a flow diagram depicting an exemplary method to venue booking and recommendations to an organizer according to the present disclosure.

FIG. 8 is a block diagram depicting rules for traversing from roomlets assigned to different groups according to the present disclosure.

FIG. 9 illustrates an embodiment of hardware implementation for the present disclosure.

FIG. 10 is a block diagram depicting an exemplary conversion of an arena into a region adjacency graph according to the present disclosure.

FIG. 11 is a block diagram depicting an exemplary conversion of an arena allocation due to re-allocation according to the present disclosure.

FIG. 12 is a state diagram depicting the various states for booking a venue according to the present disclosure.

FIG. 13 illustrates an embodiment of a hardware implementation for the methods of the present disclosure.

FIG. 14 illustrates an exemplary connection between server and computers.

FIG. 15 shows an exemplary diagram depicting outside, exterior access, and access according to the present disclosure.

FIG. 16 is a block diagram that illustrates an exemplary concave configuration of roomlets according to the present disclosure.

FIG. 17 is a block diagram that illustrates valid pathways of exit from a room according to the present disclosure.

FIG. 18 is a block diagram that illustrates valid and invalid pathways of exit from a room according to the present disclosure.

FIGS. 19-A & 19-B are graph diagrams that illustrate the changing of the reservation state of roomlets to a “blocked” state given existing and/or new Group requests.

FIG. 20 is a block diagram showing the changing of reservation states over a period of time.

FIG. 21 is a block diagram showing exemplary matrixes related to an exemplary region adjacency graph.

FIG. 22 illustrates an exemplary central reservation/registry system for a venue.

FIG. 23 is a block diagram that illustrates an exemplary embodiment of a venue display.

FIG. 24 illustrates embodiments of concavity with respect to a mathematical convex hull according to the present disclosure.

FIG. 25 shows an exemplary pre-solving method leading to a change in reservation state for certain roomlets.

FIG. 26 shows an exemplary set of graph diagrams showing assigned blocking according to the present disclosure.

FIG. 27 shows an exemplary set of graph diagrams showing unassigned blocking according to the present disclosure.

FIG. 28 is an exemplary block diagram of a report generated after the selection and assignment of a set of roomlets according to the present disclosure.

### DETAILED DESCRIPTION

The present disclosure relates to a computer-implemented approach for venue space configuration, whereby the customers (“organizers”) who wish to secure a venue decide what venue to rent using a specific set of organizer specifications combined with venue related data and organizer preferences, explicitly stated and/or implied, which thereby influence venue rental decisions and space configurations. A venue could be a restaurant, a cinema theater, a conference room, a hotel, a cruise ship, or others.

Examples for an event are: a conference, a speaking engagement, a business event with marketing stalls, a gaming event with stalls where gamers try different games, a computer game event where players bring their own computers or use computers at the venue, a show, such as a comedian show or a musical show, a theatrical play, an opera show, a scientific conference, a wedding, an artistic gathering, a beauty competition, a sport event where competitors can participate either individually or in teams an entertainment event where participants participate in entertaining activities, a spa event where participants relax through various treatments, a political event, a skill competition event, such as a math competition, a skill learning event, such as an art class, an artistic event, such as an group art event, and so on.

According to the methods of the present disclosure, prospective organizers provide preference and venue selection criteria to a provider who facilities the organization and decision making for the venue(s) rentals indicated by said criteria. These methods may be implemented on a designated apparatus such as a computer, or a system comprising several computers. Through these methods, a pre-determined price can be agreed upon for the venue rental, the venue rental can be finalized and the space can be properly configured to accommodate the organizers.

Some examples of organizer requirements may include start time and day of event, end time and day of event, type of event, event name, minimum event space required, number of roomGroups required, and minimum event space of largest room. In another embodiment, the minimum event space required, number of roomGroups required, and minimum event space of largest room may be different for each day (or other unit of time) of the event request.

When making such optimized venue related allotments, venues may consider path-feasibility. This means that each roomGroup allotted must have a pathway to the exterior of the space via a plurality of roomlets assigned to the same group, or via access through a plurality of roomlets which are unassigned.

In another embodiment, organizers that have existing space booked at a venue, may supply new requirements or change their existing requirements that cause a change in the booking.

Airwalls are defined as adjustable walls that go between specific points in the room. For example, given a plan of a room such that an airwall goes through the center of the room in N-S orientation, it follows that there are fixtures which will allow the sliding walls to move along the same line. Alternatively, an airwall may be a wall that drops from the ceiling, a wall rises from the floor, or is a portable wall added to a room. The term “wall” herein may include screens, inter-room curtains, and other forms of space dividers.

Airwalls may contain one or more doors, or may be door-less. The term “door” herein is synonymous with the term “access.”

In another embodiment, door-less airwalls that are not fully extended may be treated as having a door for the purpose of the data structures.

Roomlets are defined as the smallest subarea that a room can be divided by virtue of the presence of airwalls. RoomGroups are defined as an instance of an enclosed area made up of adjacent roomlets for assignment to an Organizer unseparated by airwalls, or as a single roomlet not adjacent to other roomlets assigned to the same Organizer.

Re-allocation is defined as the process of changing the assignment of a plurality of previously assigned groups in order to accommodate a new group's requests. In case of re-allocation, in a given embodiment, the new costs may be borne by the group being assigned the current new room and roomlet configurations.

Space is defined as an area that is under the control of the venue for event usage.

Access is defined as a means for entering or leaving a roomlet or space.

Assignment is defined as the selection of at least one RoomGroup of space for an entity within a given unit of time.

Group is defined as a unique organizer entity that is composed of roomGroup requests and/or assignments.

Attendee is defined as a person that attends an event.

Pathway is defined as a traversable connection between two roomlets or a roomlets and an exterior access.

Exterior Access is defined as the intended access to the exterior of the space. For example, an exterior access in a hotel might lead from the selected space to the lobby of the hotel. An exterior access may also be an access leading to the outside.

Outside is defined as areas external to the venue.

Arena is defined as the area within the layout editor that a layout can be created.

Polyline Edges is defined as a connected series of straight or curved line segments of defined edge types.

Polygon Edges is defined as polyline edges that form a closed polygon.

Edge Types can be, for example, doors, walls, windows, floor sections, ceilings, among others.

Concavity is defined as similar to what concavity would be defined as for closed-shaped geometric objects. In another embodiment, a threshold of concavity may be considered before an object is defined as having concavity. For example, a convex hull may be applied to the geometric object, and if the geometric object is concave, but the ratio between the area of the concave object and the convex hull of the object is greater (or, in another embodiment, less than) than the threshold, then the object may not be considered as having concavity.

For the detailed description, to clearly articulate and convey the explanation, specific details are provided herein of the invention. However, the invention can be used without these specific details.

Various features of example embodiments of the present disclosure are described in details in the following respective sections: (1) arena creation; (2) region adjacency graphs; (3) multiple floor venues; (4) valid/invalid group allotments; (5) valid/invalid pathways; (6) communication system; (7) recommendation system (8) re-allocation (9) state systems; (10) implementation methodology; and (11) concave arrangements.

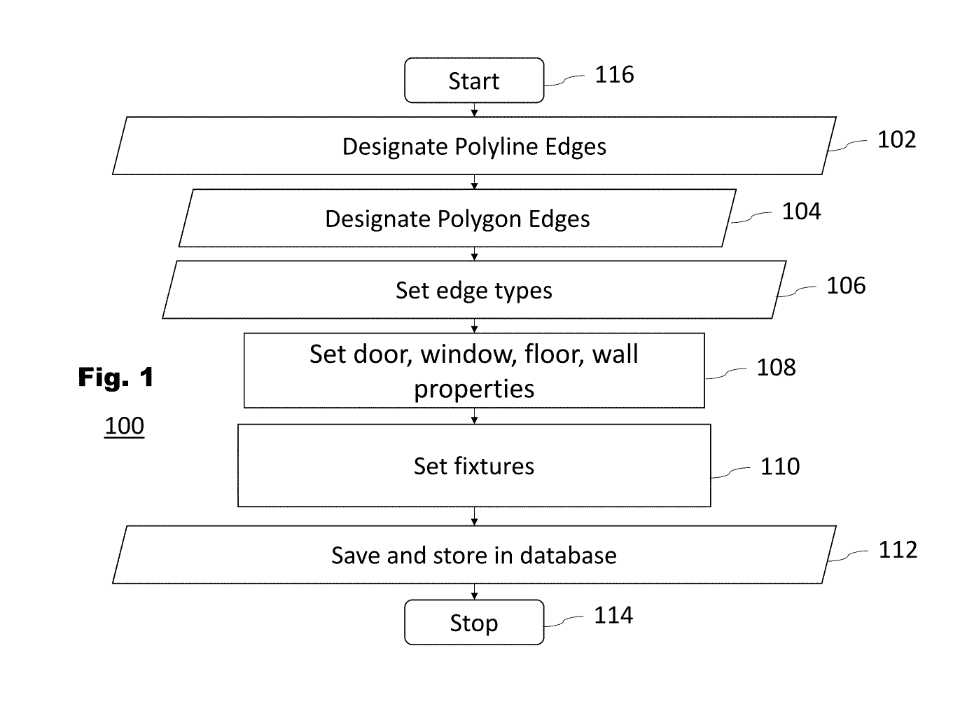

FIG. 1 illustrates an exemplary method (100) of creating a representation of venue related information to either be stored in a venue system and/or provider system. The process starts (116) and a user may designate polyline edges (102) which can be set to various edge types (106) of, but not limited to, wall, air-wall, door, window, with various options amongst each category therein. The user may also designate polygon edges (104) and later set edge types (106) with various types of flooring as options. Then a user may further decide properties of doors, windows, floors, walls (108) including, but not limited to, textures, direction of closing/opening, height, elevation, width, and/or thickness. Subsequently, a user may designate the permanent fixtures (110) within the venue space which may be, but are not limited to, pillars, lighting fixtures, electrical sockets, sound systems, and/or ventilation systems. After the completion of arena creation the user may save the layout and the information may be converted into a simplified data structure and stored in the database (112). The process then ends (114). In one embodiment, a system to handle all the data and processing described In FIG. 1 can be realized through a website built using Microsoft .NET® and Unity® platform and combining markup languages, database management tools and programming languages such as HTML/CSS, SQL, Python®, Javascript® and C#®. In another embodiment other platforms and languages may be used to build such a website.

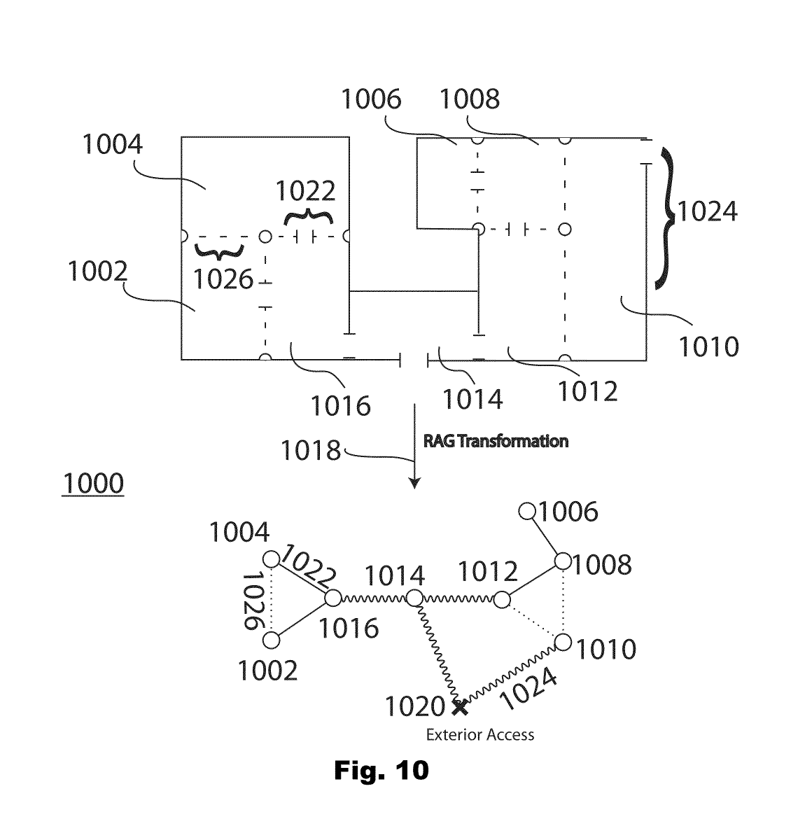

FIG. 10 illustrates the conversion of a venue space (1000) into a simplified data structure used by the provider. In this exemplary method a venue space is shown that is composed of many sub-sections called roomlets (1004, 1002, 1016, 1014, 1012, 1006, 1008, 1010). Three different wall types are designated through (1026, 1022, 1024). A solid wall with a door is designated (1024). An air-wall with a door (1022) and an air-wall with no door (1026) are further designated.

A “simplified data structure” as used herein designates a data structure such as a matrix composed of binary elements which can be visually represented by simple element such as lines and nodes, which represent a more complex structure in the real world, such as rooms and pathways.

One example of the creation of a simplified data structure is where the input information is converted into a Region Adjacency Matrix by a process termed RAG transformation (1018), visually represented through a Region Adjacency Graph. The various roomlets may be designated as circular nodes in this RAG graph. The air-wall with no door is denoted as the dotted line on the example graph (1026). The air-wall with a door is denoted by a solid line on the graph (1022). The solid wall with a door is denoted by the squiggly line on the graph (1024). Pathways from each node are displayed on the graphs.

In another embodiment, there may be additional types of pathways, for example, solid walls with no doors dividing two rooms.

RAG transformation may be realized, for example, in one embodiment through encoding in Unity® and communication with a .NET® platform and combining markup languages, database management tools and programming languages such as HTML/CSS, SQL, Python®, Javascript® and C#®. In other embodiments, other platforms and languages may be used to build such a website. For example, the database may be designed such that the data structure for defining the walls consists of 3D vertices connected by edges. These vertices have a list of other vertices to which they are connected by an edge. Edges are of a specific type, for example, but not limited to, solid wall, airwall, door in solid wall, door in airwall, or window. Each instantiated vertex and each instantiated edge are identified by unique IDs. From here a roomlet determination, in one embodiment, may be done by first having all edges not enclosing an area, and the associated vertices, removed. Roomlets are found by starting at any vertex and recursively traversing the connections, always selecting the rightmost edge, until returning to the starting vertex. Connections are marked as used as they are traversed so they will always be used exactly once. Because the connections are bi-directional, each edge will be traversed exactly twice, once in each direction. The accumulated angle formed by the pair of edges at each vertex is kept. When the starting vertex is reached, a roomlet is defined and the accumulated angle will be 360 or −360 degrees. Since this is a right-hand traversal, a positive 360 indicates an interior roomlet, and a negative 360 indicates the exterior of a connected vertex network. Exterior roomlets are further examined to determine whether they are contained within an interior roomlet, and if so, the list of edges of the contained exterior roomlet may be concatenated with the list of edges of the containing roomlet, and the exterior room is removed. Roomlet numbering may be remapped (compressed) to remove roomlets with no walls, and to move the one remaining exterior roomlet to the highest index. From here the adjacency matrix may be created in one embodiment by first setting all elements of the Adjacency Matrix (“AM”) are initialized to no connection. For each roomlet, lists of solid wall edges, airwall edges, and door edges are generated. Then the lists of edge types are scanned roomlet by roomlet for matching edge IDs, and the appropriate AM elements are set to the edge type for matching edges. Priority of edge types may be determined by the order in which the lists of edge types are scanned.

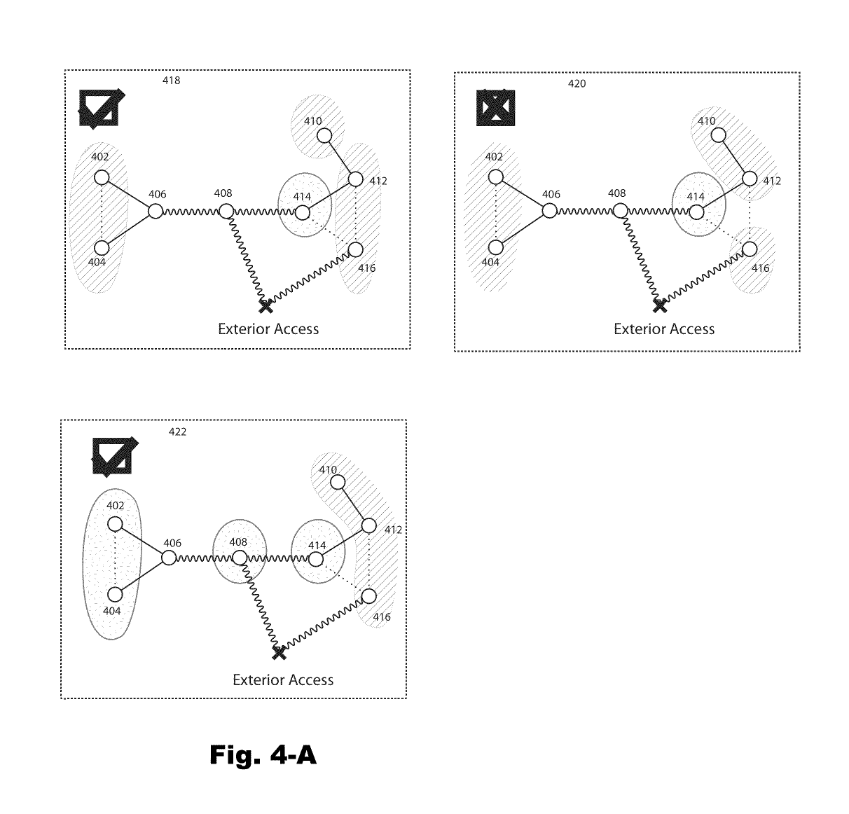

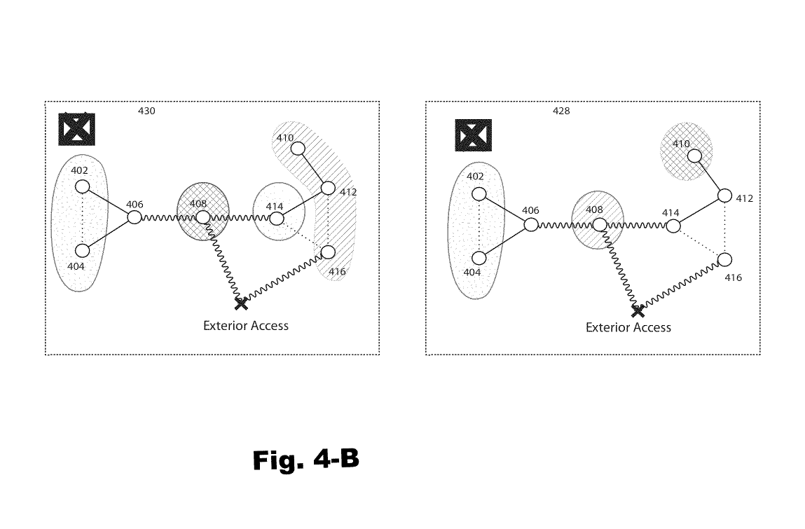

In FIGS. 4-A, and 4-B various exemplary diagrams are shown for a room and its roomlet (402, 404, 406, 408, 410, 412, 414, 416) allocations. These exemplary diagrams illustrate a model of venue assignments and validity checks when re-allocation is possible.

In one example diagram (418), there are two groups. One group is illustrated with three roomGroups (402, 404; 410; 412, 416) composed of five roomlets where (402, 404) and (412, 416) are each treated as each one roomGroup with their dividing air-wall open. One roomlet (414) is designated to another group. This arrangement is designated as being valid because both groups have exits to the exterior access from all roomlets and roomGroups without having to enter space occupied by another group.

In another example diagram (420), there are two groups. One group is illustrated with three roomGroups (402, 404; 410, 412; 416) where (402, 404) and (412, 410) are each treated as one roomGroup with their air-wall open. One roomlet (414) is designated to another group. This arrangement is designated as being invalid because both groups do not have exits to the exterior access from all roomGroups without having to enter space occupied by another group.

In another example diagram (422), there are two groups. One group is illustrated with three roomGroups (402, 404; 408; 414) where (402, 404) is treated as one roomGroup with their air-wall open. One roomGroup (410, 412, 416) are designated to another group. This arrangement is designated as being valid because both groups have exits to the exterior access from all roomlets and roomGroups without having to enter space occupied by another group.

In another example diagram (428), there are three groups. One group is illustrated with one roomGroups (402, 404) where (402, 404) is treated as one roomGroup with their air-wall open. One roomlet (408) is designated to another group. A third group has a specific roomlet configuration (410) as shown in the Figure. This arrangement is designated as being invalid because all groups do not have exits to the exterior access from all roomGroups without having to enter space occupied by another group.

In another example diagram (430), there are three groups. One group is illustrated with two roomGroups (402, 404; 414) where two roomlets (402, 404) are treated as one roomGroup with their air-wall open. One roomlet (408) is designated to another group. A third group has a roomGroup (410, 412, 416) with its airwalls open. This arrangement is designated as being invalid because all groups do not have exits to the exterior access from all roomGroups without having to enter space occupied by another group.

A physical transformation of the room may refer to any number of the following:

(1) Change the display of the reservation state of one or more roomlets on a display at the venue intended for viewing by the attendees of the events at that venue.
(2) Airwalls are NOT adjusted to be closed between adjacent roomlets if they belong to the same roomGroup.
(3) Adjust airwalls at appropriate locations such that:
1. Unless two adjacent roomlets are under categories defined below, an airwall should be open between them. The categories of adjacent roomlets that necessitate the airwall between two roomGroups to be up are:
   a. the two roomlets belong to different roomGroups
   b. one roomlet is unassigned, and the other is assigned to a roomGroup
2. From every assigned roomlet there exists a pathway to the exterior access.
   (4) Fixed doors and doors on airwalls are unlocked and openable AND appropriate airwalls between unassigned roomlets are adjusted to be open in order to create a physically traversable path from any roomlet X assigned to roomGroup R1 assigned to group G to the exterior access such that the path consists only of roomlet connectors like doors, elevators, stairs, pathways, etc., and roomlets which are either unassigned, or is assigned to any roomGroup R2 which is assigned to the same group G.
   (5) The presence or absence of particular room accoutrements, such as a stage, lighting, projector screen, projector, sound system, internet access, dance floor, tables, or others.
   (6) Any other physical attribute of the room, such as interior decoration, soundproofing, temperature control, etc.

The above-mentioned physical transformations may be performed manually by people at the venue, or they may be performed automatically through command signals sent from one part of the system to a computer control located at the venue which has computerized control of the physical transformation.

In one embodiment of this transformation, the hotel's room specifications are coded using
Two binary m×m interaction map (BMMI map) showing the connectivity between the m roomlets of the hotel.
   The first BMMI map in this embodiment is a binary map referred herein as E1 which will code one at position E1(i,j) if roomlet i and roomlet j have an airwall between them and zero otherwise.
   The second BMMI map in this embodiment is a RAG or Region Adjacency Graph which referred herein as E2 which will code one at position E2(i,j) if roomlet i and roomlet j have a physically traversable roomlet connector between them such that you can move from roomlet i to roomlet j without traversing other roomlets.
An m×1 array which indicates whether each roomlet is connected by a physically traversable connector to the outside.
An m×1 array which specifies the price per square foot (or any other means of measurement) of a roomlet.
An m×1 array which specifies the area of each roomlet.
An m×1 array which indicates the roomlets that are unavailable for booking anymore.

Example: Suppose there are G groups (numbered from 1 to g) that are trying to find meeting room accommodation in the hotel:

For this example, each Group g's request is coded using the following parameters (other requirements may exist in other Group requests):
A single number specifying the number of roomGroups required (n_{g}).
A single number specifying the minimum area required of the roomGroup with the maximum area (MA(g)).
A single number specifying the minimum Total Area required (TA(g)).

A solution may consist of a set of binary numbers which consists of at least the following:
x(i,j,g) where 1≦i≦ng, 1≦j≦m, 1≦g≦G. Where x(i,j,g)=1 indicates that that roomlet j has been assigned to the i-th roomGroup request of group g.
Y1(i,j) where 1≦i≦m and 1≦j≦m. Where Y1(i,j)=1 indicates that roomlet i and roomlet j are connected by an airwall AND the airwall is removed after the assignment in order to follow problem stipulations.
Y2(i,j) where 1≦i≦m and 1≦j≦m. Where Y2(i,j)=1 indicates if given the current configuration of airwalls and doors, is it physically possible to move from roomlet i to roomlet j without passing through any other roomlet.
Y3(i,j,k) where 1≦i≦m and 1≦j≦m and 1≦k≦m. Where Y3(i,j,k)=1 indicates that in a trip from outside to roomlet k, a passage from roomlet i to roomlet j is plausible.
   If roomlet k is assigned to a Group, then Y3(i,j,k) is one if (if and only if):
      Y2(i,j)=1 AND . . .
      neither romlet i nor roomlet j is assigned to a Group that is not the same as the Group k is assigned to.
   If roomlet k is NOT assigned to a Group, then Y3(i,j,k) is given the same value as Y2(i,j)
F(i,j,k) where 1≦i≦m and 1≦j≦m and 1≦k≦m. Where F(i,j,k)=1 indicates that in an instance of a solution a trip from outside to roomlet k contains a traversal from roomlet i to roomlet j.

In one embodiment of a process to solve the problem, a binary integer linear programming methodology is utilized where each of the binary solution variables described above are part of a linear solution vector.

Each of the conditions enlisted above can be easily converted into mathematical constraints. Each of the organizer specs are also converted into mathematical constraints.

In one embodiment of the process, the solution vector is optimized, or attempted to be optimized, by reducing the total cost for all the groups. In another embodiment of the process, the solution vector is optimized, or attempted to be optimized, by increasing the total profit to the venue.

In one embodiment, we may reduce the Binary Integer Linear Programming problem to a satisfiability problem.

In one embodiment, we may iteratively generate multiple solutions using a suitable linear programming solver by precluding previously generated solutions by adding additional constraints.

In one embodiment, we may use commercially available linear programming solvers like Gurobi®, CPLEX® etc. to solve the linear program. In another embodiment other solvers may be used to execute such a process.

In one embodiment, we may formulate the entire problem as a set of linear equations with binary coefficients and use methods such a LASSO to solve for the unknown variables.

In one embodiment, the optimization function may be quadratic and we will use a suitable solver to solve for the variables while satisfying the constraints and maximizing (or minimizing) the optimization functions.

In one embodiment, we may use a brute force or a greedy algorithm or a new systematic algorithm to solve the problem.

In one embodiment, we may add or drop variables, and make or drop assumptions about the problem without disturbing the theme of assigning rooms to multiple group requests in the presence of airwalls while securing a pathway to the exterior access for each group.

One skilled in the art would understand that other embodiments may be realized using well known techniques.

FIG. 3 illustrates a region adjacency graph with multiple floors. A1-A15 represent roomlets within a venue, also graphically indicated by circular nodes. This diagram further illustrates the addition of the new pathways—stairways (302), and elevators (304). Other pathways such as solid walls with doors (308), solid walls with no doors (310), air-walls with no doors (314) and air-walls with doors (312) are shown. In another embodiment, escalators may be construed and considered within the same category of pathway as stairs.

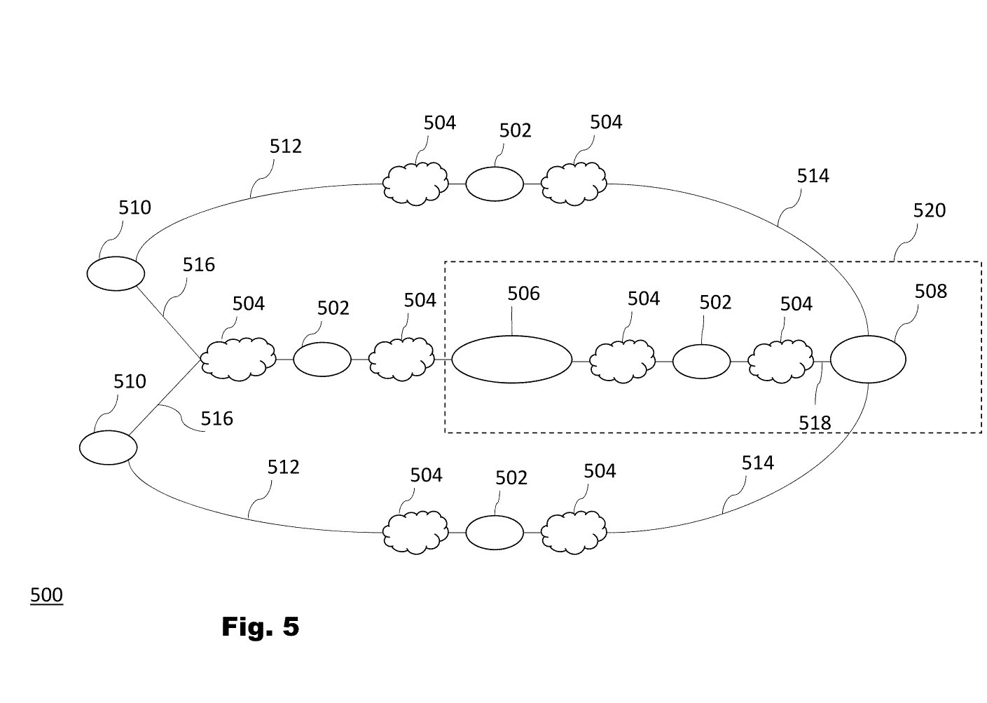

FIG. 5 illustrates an exemplary communication system (500) between attendees, venues and organizers. An attendee (510) can communicate through an internet connection device (504) with a provider (502) through channel (516). The provider (502) can communicate with the attendee (510), organizer (506) and venue (508). An attendee can communicate with a provider also through channel (512), and, in turn, a provider (502) can also communicate directly with a venue (508) through channel (514). The organizer (506) can communicate with the venue (508) through communication channel (518) by way of the provider. The subset of communications denoted by (520) is the totality used for this current process. The rest of the communication system has been shown for clarity. The devices of FIG. 5 may also operate on a private network rather than a public network.

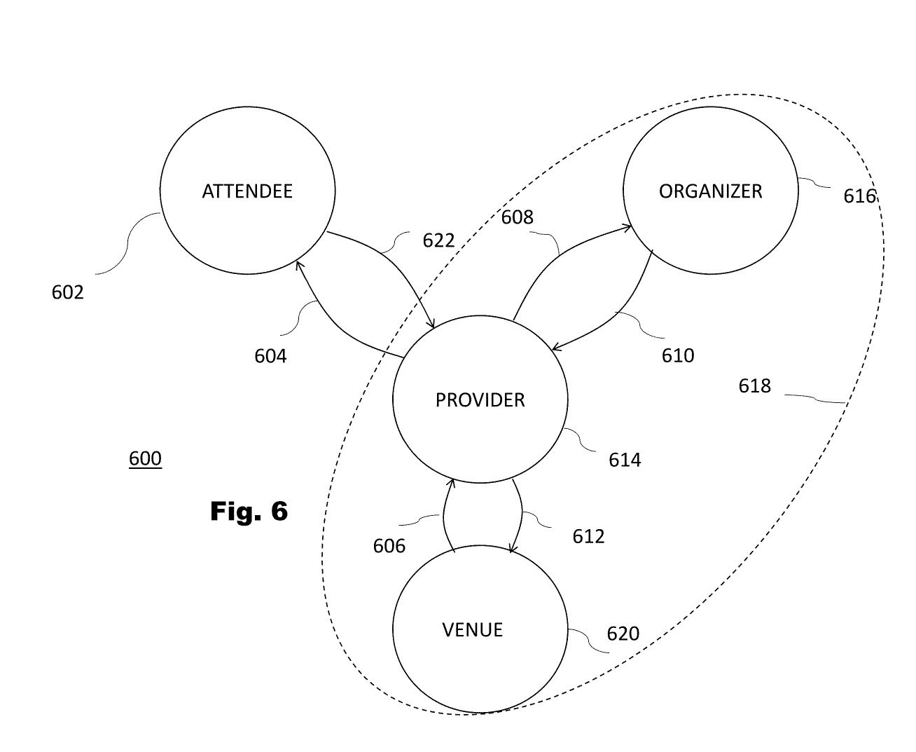

FIG. 6 illustrates an exemplary communication system (600) between attendees, venue and organizers. An attendee (602) can communicate with a provider (614), or vice versa, through channels (604, 622). An organizer (616) can communicate with a provider (614), or vice versa, through channels (608, 610). A provider (614) can communicate with a venue (620), or vice versa, through channels (606, 612).

Organizer and Venue have been shown as being part of the set (618) for clarity of explanation on the communication processes involved to execute the processes of the current disclosure.

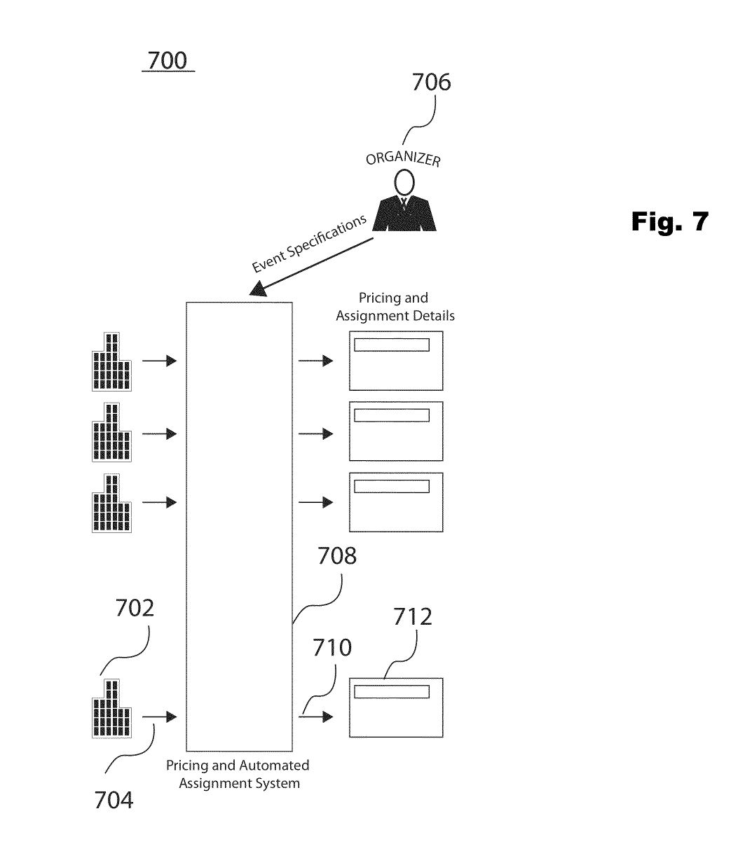

FIG. 7 illustrates an exemplary process (700) of the embodiment. A venue, for example a hotel, (702), feeds their venue related information (704) into the automated pricing and assignment system (708) which then recommends (710) pricing and assignment details (712) and displays those details to an organizer (706)

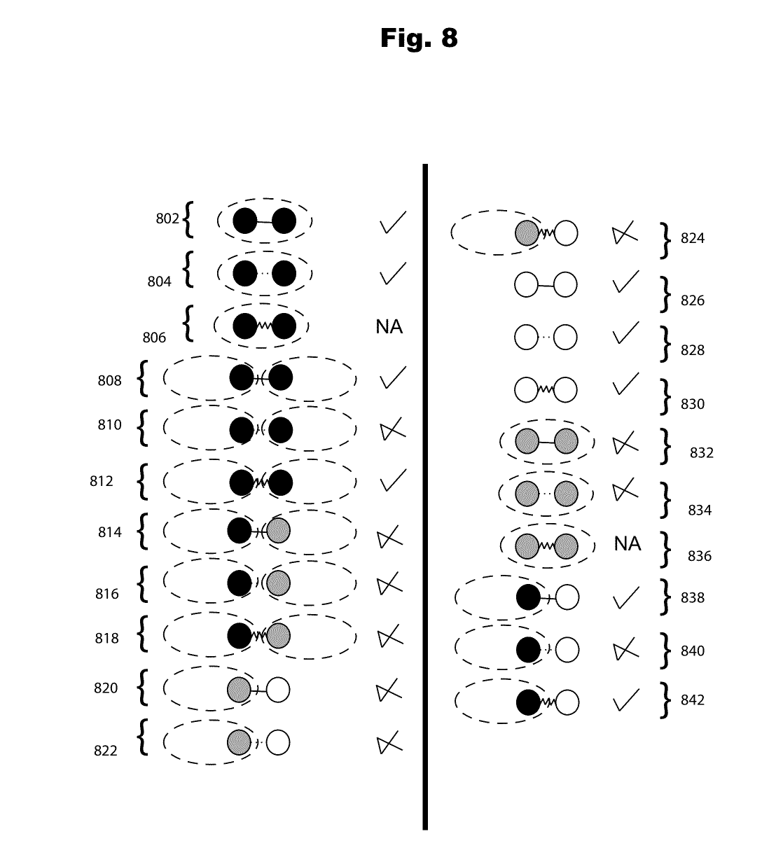

FIG. 8 displays an exemplary process for traversing from roomlets assigned to different Groups (800) through the viewpoint of the black node. Two different groups are displayed, one as the black node, and one as the grey node. An unoccupied roomlet is also shown through the white node. Valid traversable pathways are shown (802, 804, 808, 812, 826, 828, 830, 838, 842). Invalid traversable pathways are also shown (810, 814, 816, 818, 820, 822, 824, 832, 834, 840). Further, traversable pathways that are not applicable or possible are shown (806, 836). Different connection types are shown in the provided examples. The dotted eclipses designate a roomGroup. The connection type of lines as in (802) represent airwalls with doors. The connection type of dots as in (804) represent airwalls with no doors. The connection type of squiggly lines as in (806) represent solid walls with doors.

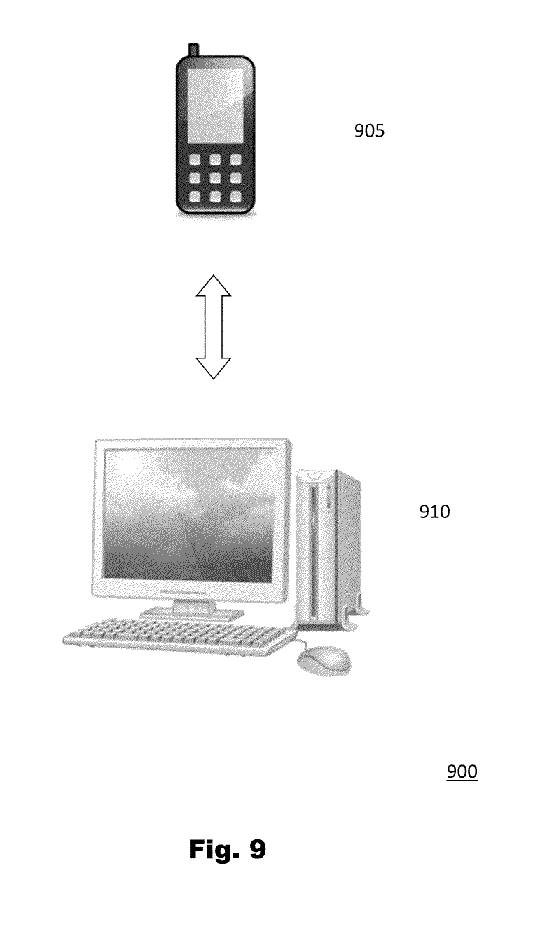

FIG. 9 illustrates an example embodiment (900) of the present disclosure, where an application is running on a smartphone (905) and communicates with a computer (910), e.g. a desktop computer. For example, the smartphone may belong to a venue organizer and the computer to the provider. Other hardware devices may be used, for example, but not limited to, a tablet instead of a smartphone.

The person skilled in the art will understand that several steps in the methods described in the present disclosure may require a hardware implementation. For example, but not limited to, a tablet, smartphone, server or other computer may be needed to implement one or more steps of the methods described herein.

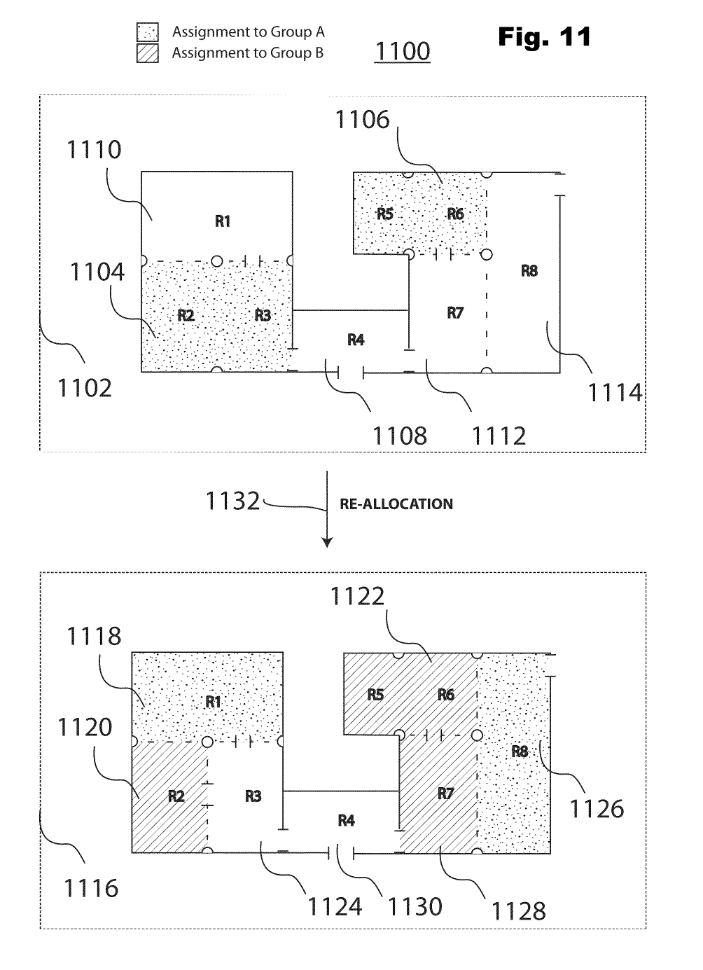

FIG. 11 illustrates an exemplary diagram (1100) showing re-allocation (1132). R1, R2, R3, R4, R5, R6, R7, R8 exemplify different roomlets of a given venue space. In the first example model shown (1102), R2, R3, R5, R6 are allocated to one group and denoted by two roomGroups (1104, 1106). Upon the introduction of a second group, the recommendation system adjusts the placement of the initial group as displayed in diagram (1116). This adjustment is done to attempt to increase the utility of the overall room while adhering to all organizer requirements. In the secondary diagram (1116), one group is allocated space as roomGroups (1118, 1126). Another group has been allocated space as roomGroups (1120, 1122, 1128). Unoccupied space is denoted by (1124, 1130). Given the constraints provided by the two groups initially, this configuration of the space provides the best overall utility for both parties, while being a valid configuration with a pathway of exit for all parties.

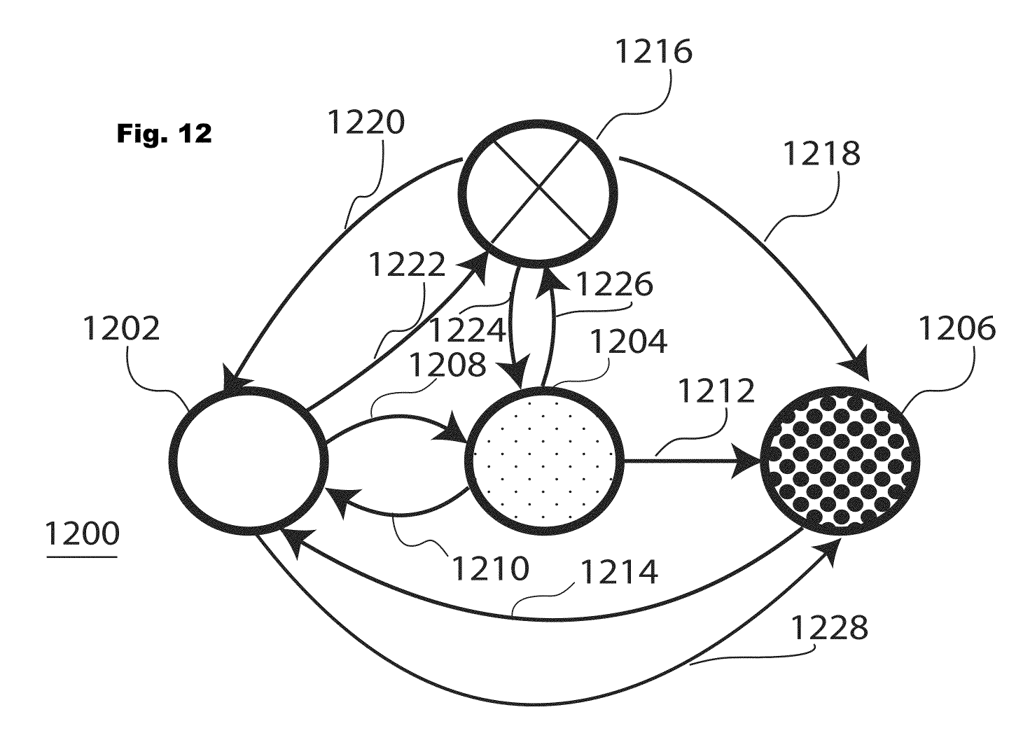

FIG. 12 illustrates an exemplary state diagram (1200) for venue allotments. A roomlet or roomGroup within a venue space is initially considered unoccupied and free for use (1202) and then undergoes a booking process (1208) and becomes placed on hold or tentatively booked (1204). In another embodiment, the room may remain tentatively booked until the organizer specifies the room arrangement within the room. In a further embodiment, the room may remain tentatively booked until a certain threshold of time prior to an event. In a further embodiment, a room remains tentatively booked because it is a non-premium booking, and the venue has multiple tiers of booking: premium and non-premium. Until then it can return directly to free allotment by the process (1210). It can also undergo a process (1212) and become confirmed-booked (1206) and then cannot be changed by re-allocation or otherwise until the completion of its use or by method of cancellation and return by process (1214) to the free and unoccupied state (1202). There may also be a method of booking where a premium booking is undertaken by method (1228) resulting in a change from the free to use state (1202), to the confirmed state (1206). In certain situations there may also be a means that a venue space may become blocked (1216) such that it cannot be occupied by any Group by method (1222). In such a situation the blocked space can return to free to use by method (1220), or change to/from the tentatively booked state via method (1224, 1226), or change to the confirmed state via method (1218). This process and diagram is relevant with respect to specific time periods for the bookings. Once the room or rooms are reserved, tentatively or confirmed, to an organizer, a report may be generated providing the details of the reservation.

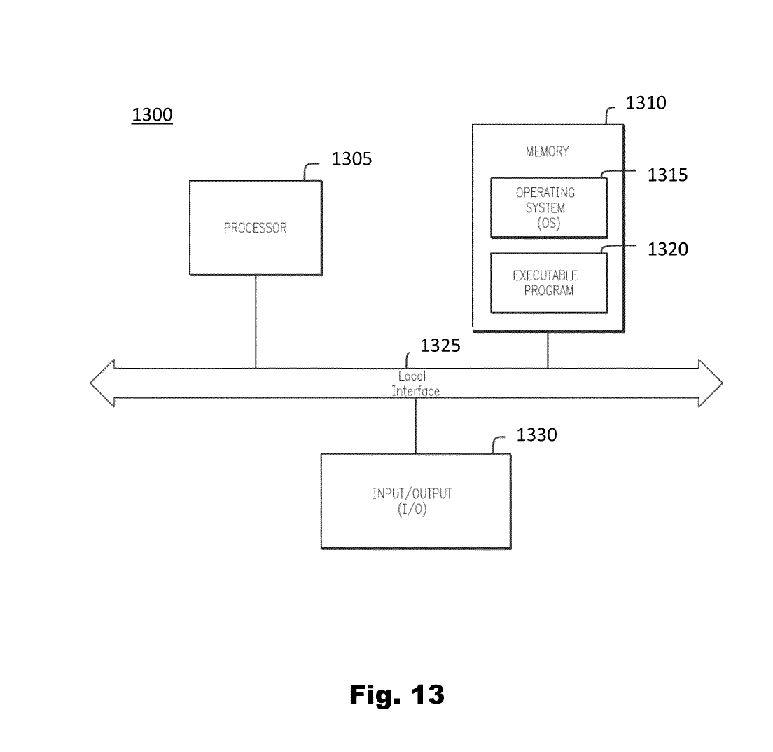

FIG. 13 is an exemplary embodiment of a target hardware (1300) (e.g., a computer system) for implementing the embodiment of FIGS. 1-12 and FIGS. 14-28. This target hardware comprises a processor (1305), a memory bank (1310), a local interface bus (1325) and one or more Input/Output devices (1330). The processor may execute one or more instructions related to the implementation of FIGS. 1-12 and FIGS. 14-28, and as provided by the Operating System (1315) based on some executable program (1320) stored in the memory (1310). These instructions are carried to the processor (1305) via the local interface (1325) and as dictated by some data interface protocol specific to the local interface and the processor (1305). It should be noted that the local interface (1325) is a symbolic representation of several elements such as controllers, buffers (caches), drivers, repeaters and receivers that are generally directed at providing address, control, and/or data connections between multiple elements of a processor based system. In some embodiments the processor (1305) may be fitted with some local memory (cache) where it can store some of the instructions to be performed for some added execution speed. Execution of the instructions by the processor may require usage of some input/output device (1330), such as inputting data from a file stored on a hard disk, inputting commands from a keyboard, inputting data and/or commands from a touchscreen, outputting data to a display, or outputting data to a USB flash drive. In some embodiments, the operating system (1315) facilitates these tasks by being the central element to gathering the various data and instructions required for the execution of the program and provide these to the microprocessor. In some embodiments the operating system may not exist, and all the tasks are under direct control of the processor (1305), although the basic architecture of the target hardware device (1300) will remain the same as depicted in FIG. 13. In some embodiments a plurality of processors may be used in a parallel configuration for added execution speed. In such a case, the executable program may be specifically tailored to a parallel execution. Also, in some embodiments the processor (1305) may execute part of the implementation of FIGS. 1-12 and FIGS. 14-28, and some other part may be implemented using dedicated hardware/firmware placed at an Input/Output location accessible by the target hardware (1300) via local interface (1325). The target hardware (1300) may include a plurality of executable programs (1320), wherein each may run independently or in combination with one another.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), a field programmable logic array (FPGA), a graphic processing unit (GPU) or a general purpose GPU).

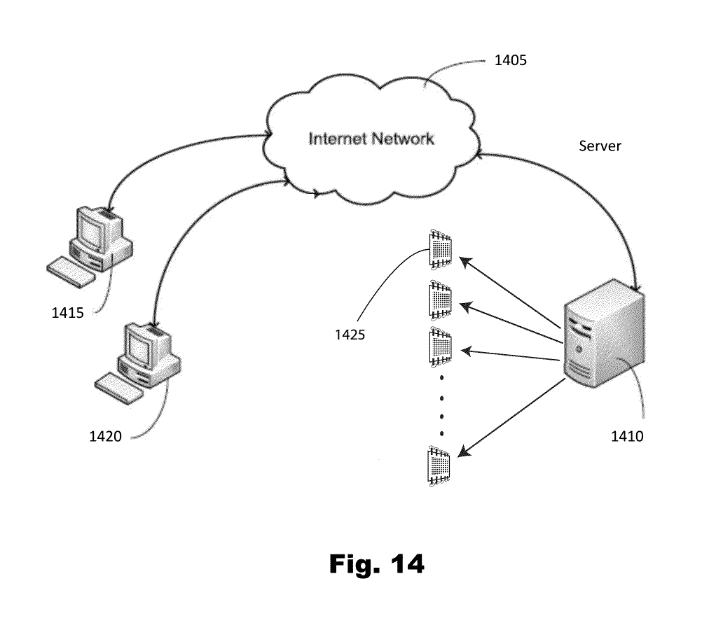

FIG. 14 illustrates an exemplary connection between a server and computers, wherein the server (1410) may run an application implementing the methods of the present disclosure. The server (1410) may connect through a network (1405) to other computers such as an organizer computer (1415), and a venue computer (1420). The server (1410) may have any number of a plurality of server nodes (1425) that can be independently or jointly used to perform a given task. A network may comprise, for example, a LAN, a WAN, or other kinds of networks as understood by the person skilled in the art. Such networks may be wholly or partly private networks.

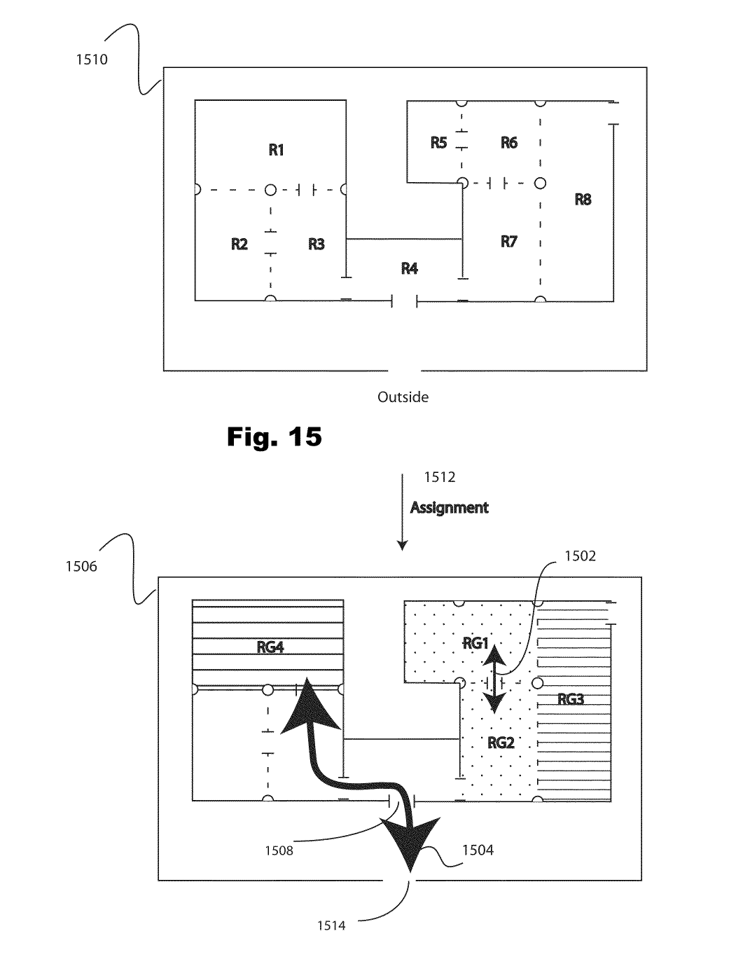

FIG. 15 illustrates an exemplary diagram that explains access, exterior access, outside, etc. The initial venue is shown through (1510). After assignment (1512), the venue is shown through (1506). RG1, RG2, RG3, RG4 represent various roomGroups. R1-R8 represent various roomlets. A method of access between RG1 and RG2 is shown through the arrow (1502). A method of access through the exterior access (1508) to the outside (1514) is shown the arrow (1504) between RG4 and the outside.

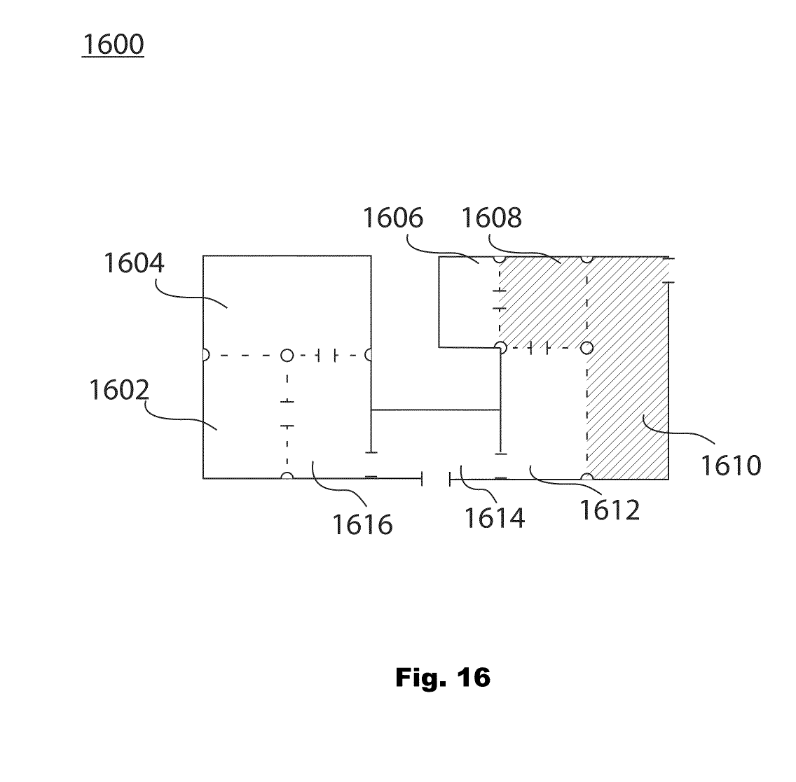

FIG. 16 shows an example of a room (1600) which is composed of roomlets (1602, 1604, 1606, 1608, 1610, 1612, 1614, 1616). In the exemplary diagram two roomlets are occupied and their dividing airwall is removed (1608, 1610) producing a roomGroup. This occupied roomGroup configuration has concavity which may not be ideal to some organizers. In an embodiment of the present disclosure, the method may look for all concave roomlet arrangements and restrict setting roomGroups as concave for a group based on organizer requirements or preferences.

In an embodiment, venues may choose to allow or not allow re-allocation, either on a case-by-case basis or overall. In such an embodiment a process, involving either the re-allocation method or non-re-allocation method, may run to find an appropriate set of recommendations for the organizer.

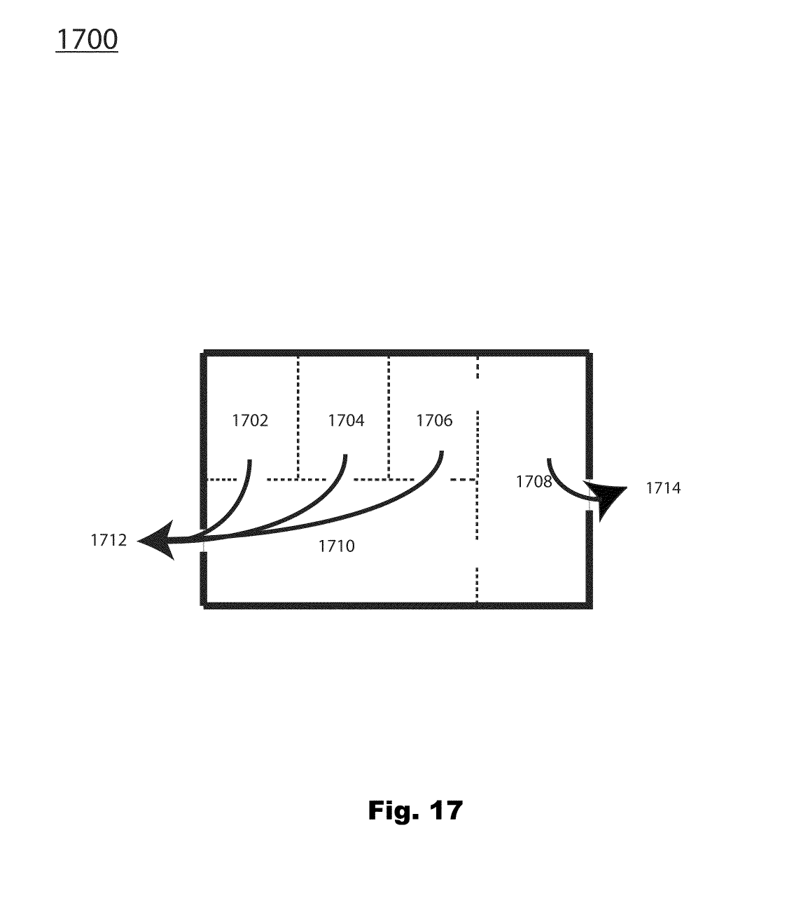

FIG. 17 shows an example of some valid pathways from a room at a venue where re-allocation is not possible. Roomlet (1702, 1704, 1706, 1708) are shown with a valid pathway (1712, 1714) with access to the exterior access in the event (1710) is unassigned.

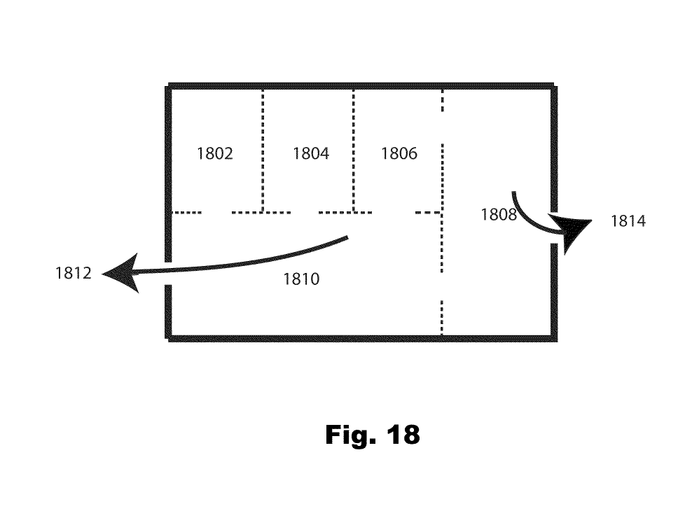

FIG. 18 shows an example of invalid allocation where re-allocation is not possible. In the event roomlet (1810) and (1808) are assigned to a group, they both have valid pathways (1812, 1814) to the exterior access. However, given re-allocation is not possible, venue utility is lost because (1802, 1804, 1806) have invalid pathway and thereby cannot be assigned to any other Group for that given time point of booking. In an embodiment of such a non-allocation case, optimal packing arrangements may be desired and attempted to be achieved.

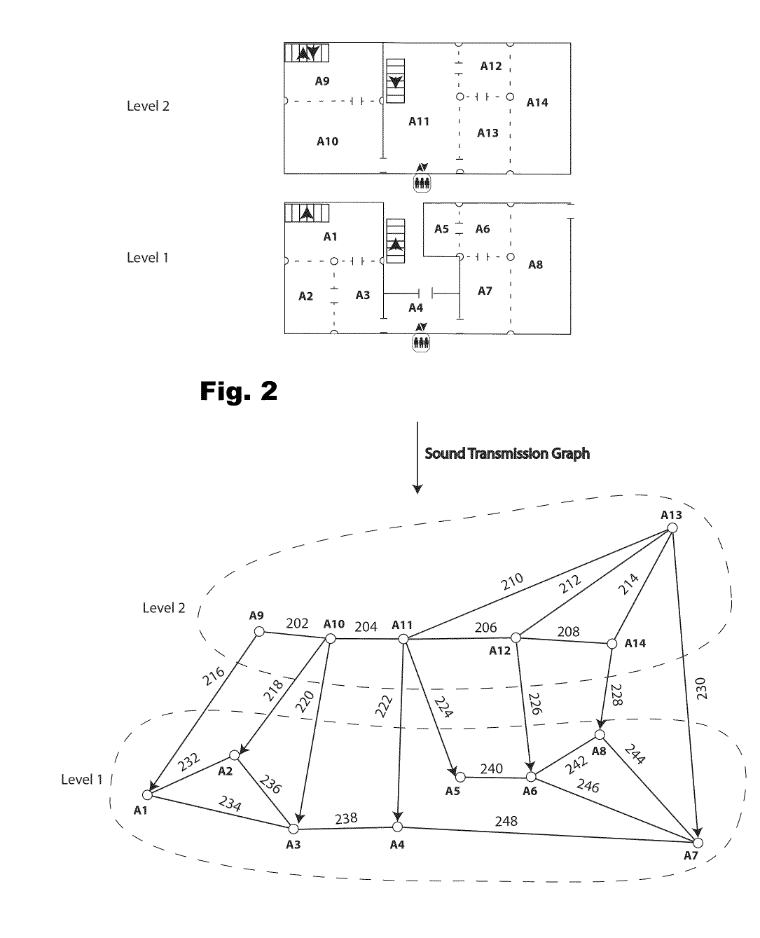

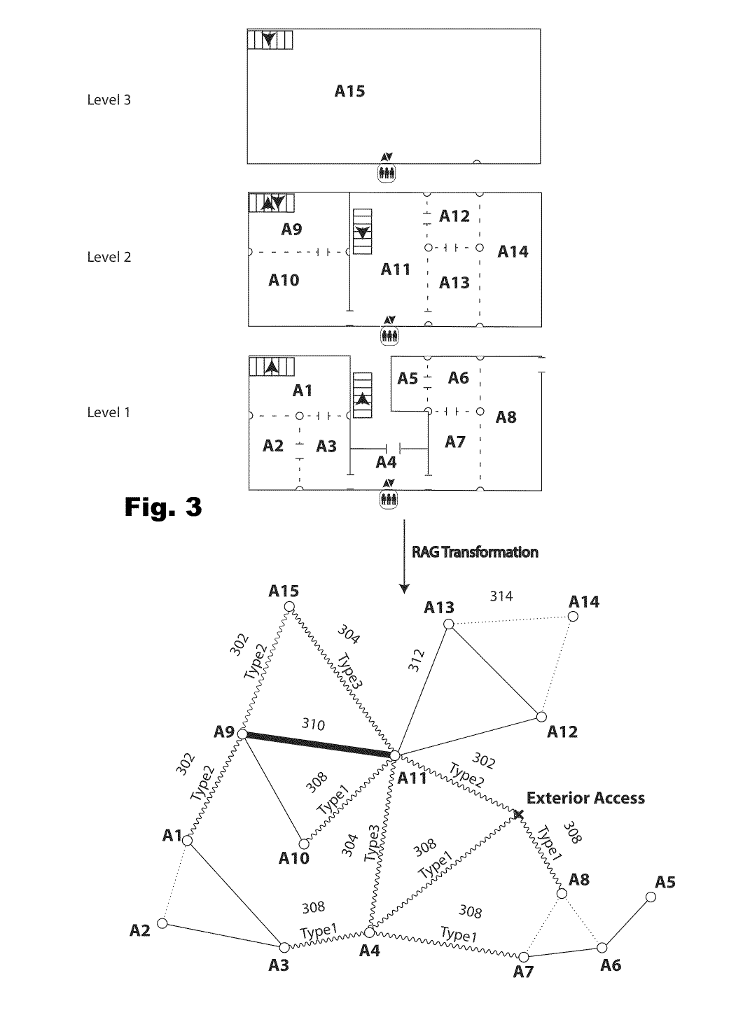

In one embodiment of the invention a set of constraints may be included which will use a sound transmission graph such as one depicted in FIG. 2. This graph maps adjacency of rooms and stores information about what kind of boundaries they share that may include, but is not limited to, if the boundary is of ceiling-floor type or adjacent rooms on the same level, maximum possible area of sound flux, material used to make the boundary and related sound transmission coefficients.

In one embodiment of the invention the information stored in the last section together with maximum noise thresholds is used to build a set of constraints such that no room allocation is made that will cause noise over the maximum noise threshold.

In another embodiment of the invention the assignment of rooms is done such that sum of the noise from neighboring rooms is minimized.

In FIG. 2 ceilings between floors are shown through (216, 218, 220, 222, 224, 226, 228, 230). Walls between roomlets are shown through (202, 204, 210, 206, 212, 208, 214, 240, 242, 246, 244, 248, 238, 236, 234, 232). A1-14 indicate different roomlets within the venue space and are represented by the circular nodes on the graph.

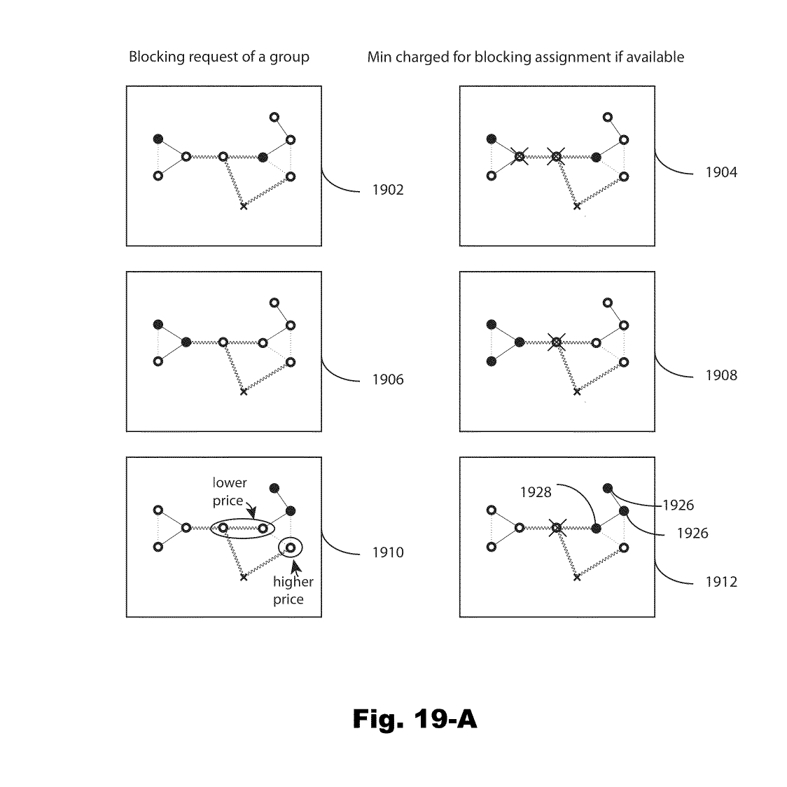

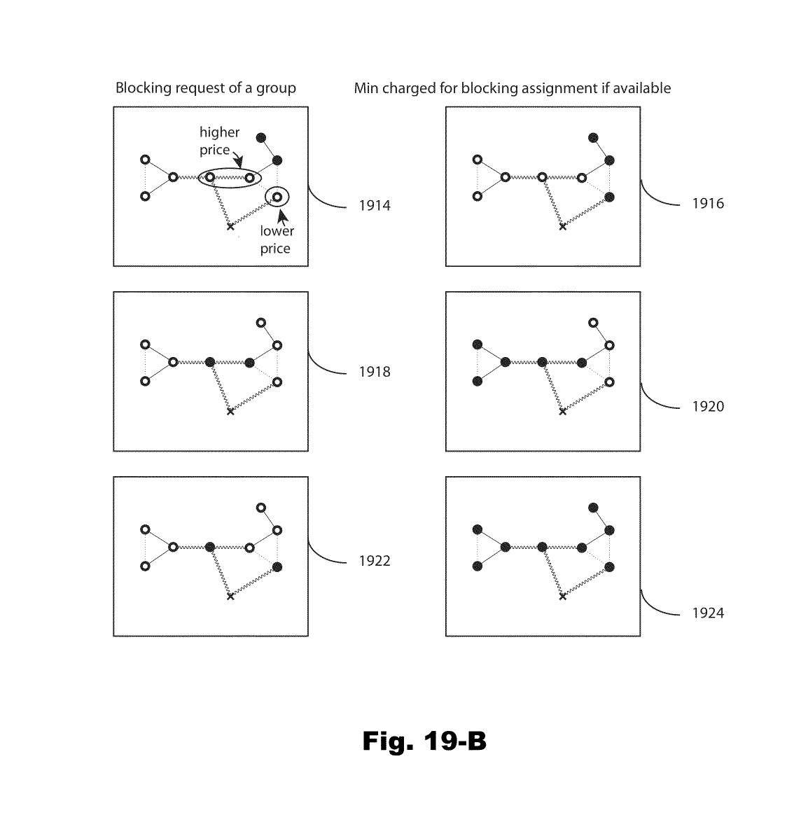

FIGS. 19-A and 19-B show an example of reservation state changes for roomlets being changed to blocked based on the reservation changes of other roomlets, some of which may or may not be adjacent, to confirmed. Multiple region adjacency graphs are shown in the example FIG. 1902, 1906, 1910, 1914, 1918, 1922). The respective blocking assignments as a result of those group requests are shown in (1904, 1908, 1912, 1916, 1920, 1924). Taking one exemplary FIG. 1912), it is noted that as a result of the confirmation of assignment of a group to roomlets (1926), to allow for a traversable pathway to the exterior access, certain roomlets must be blocked; whereby in this case that roomlet cannot be used by any other Group due to such blocking it is assigned to the original group making the blocking request (1928). The X with the circle through it denotes a blocking which is unassigned to any group such that feasible pathways to the exterior remain possible.

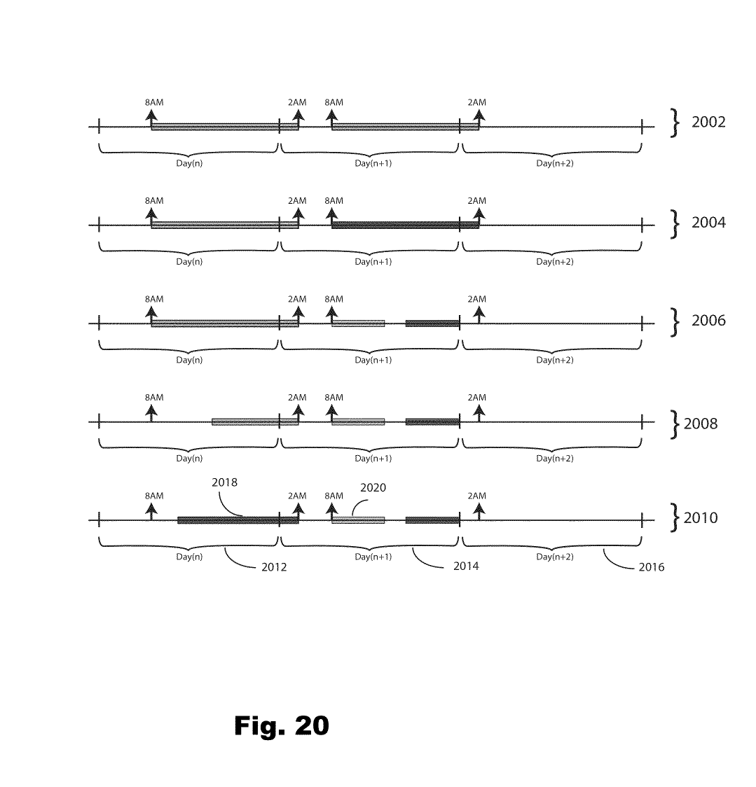

FIG. 20 shows an example of reservation state changes within rooms across a temporal window. Multiple different venue spaces are shown (2002, 2004, 2006, 2008, 2010). Taking an exemplary venue space (2010), multiple days are shown (2012, 2014, 2016), and within that temporal window shown different groups (2018, 2020) have reservations for different periods of time.

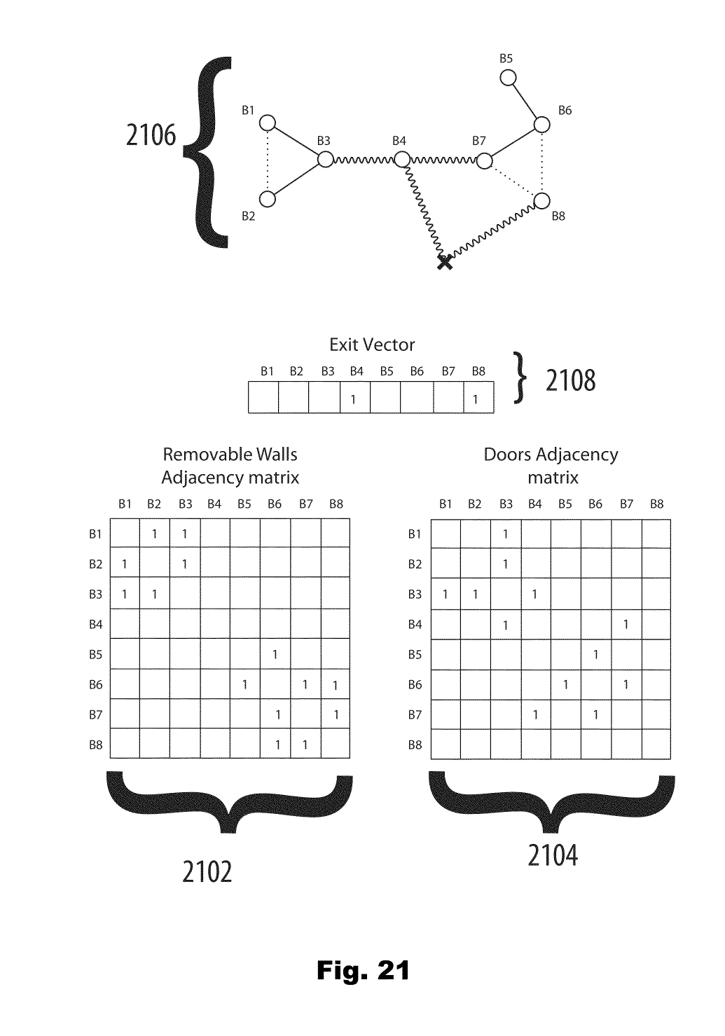

FIG. 21 shows exemplary matrices related to a region adjacency graph (2106). In the example, the removal walls adjacency matrix (2102) has been shown separately from the doors adjacency matrix (2104) which has been shown separately from the exit vector (2108). In another embodiment the two matrices may be combined and their related information shown together. In another embodiment the information may be split into more than two matrices. In another embodiment the information may be stored by some other method. B1-B8 represent various roomlets in the RAG and are represented on the horizontal and vertical axis of the matrices.

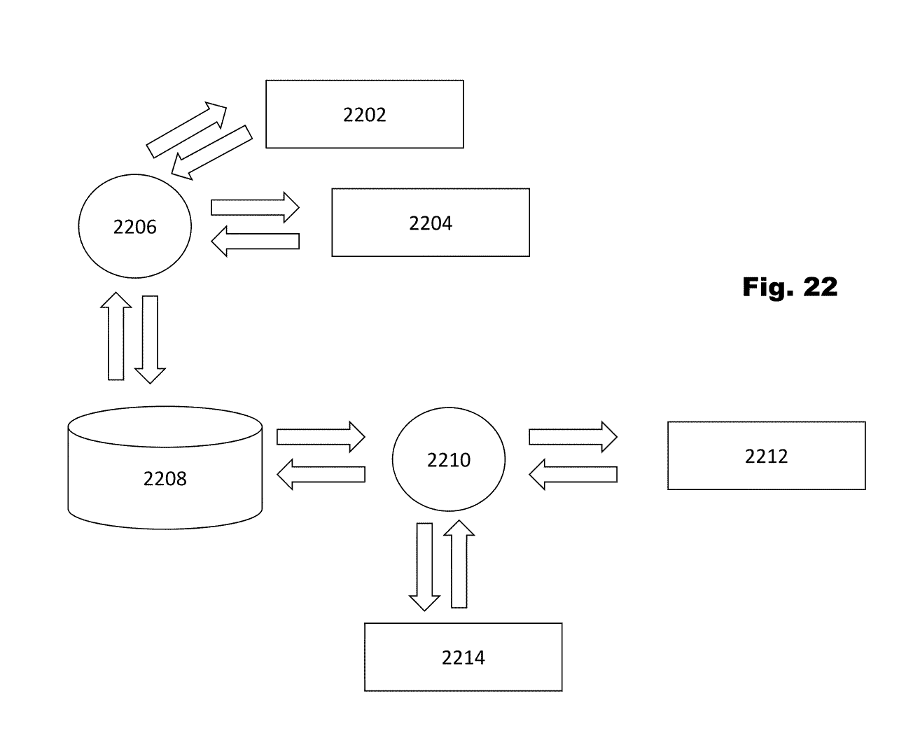

FIG. 22 illustrates an exemplary central reservation/registry system for a venue. In the block diagram depicted, the central registry is shown through (2208), which is connected to a provider platform (2206) which has venue supply information pass to/from users (2204) and can also have specifications modified by the venue (2202). The central registry is also connected to another provider (2210) which has venue supply information pass to/from users (2212) and can also have specifications directly modified by the venue (2214). In this case, a provider can be considered as a distributor the venue space. The central registry may be connected to any number of providers; in this case has been shown as two.

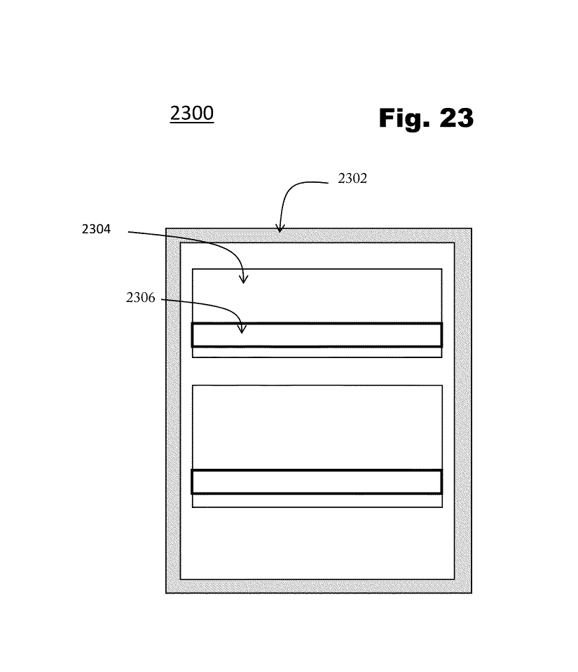

FIG. 23 is a block diagram that illustrates an exemplary embodiment (2300) of a venue display. A tablet/computer/electronic interface is shown (2302). A specific period of time, for example, over the course of one day may be shown on the screen at any given time. In another embodiment, another method of displaying the information may be used alternative to a unit of time per day. Details for an example venue space is shown (2304) and within those details the specific event details of a particular event are shown (2306). In one embodiment, this venue display may be updated automatically when a Group assignment is made to a room. Venues may have none, one, or a plurality of these venue displays. In some cases the details with respect to a venue space may be shown on different venue displays.

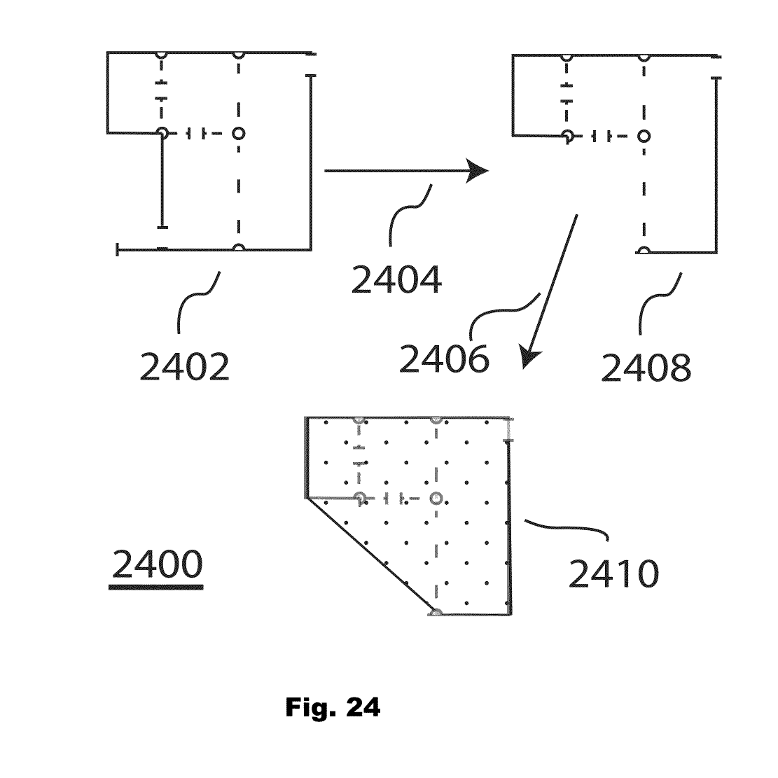

FIG. 24 illustrates embodiments of concavity (2400) with respect to convex hulls according to the present disclosure. An example room is shown (2402) and by a RoomGroup request (2404) a RoomGroup assignment is considered (2408) and by method (2406) a convex hull (2410) is applied to the room. The ratio of the area of the RoomRequest (2408) is compared to that of the Convex Hull (2410) and if the area is above a pre-set threshold, the RoomRequest may be rejected. In another embodiment if the area is below, or equal to the threshold, the rejection or acceptance may be treated differently. In another embodiment the threshold may not be a fixed value. In one embodiment such a restriction may be requested by an organizer. In another embodiment, the system may reject such configurations without the input of an organizer.

In one embodiment, a system to handle all the data and processing described earlier can be realized through a website built using Microsoft .NET® and Unity® platform and combining markup languages, database management tools and programming languages such as HTML/CSS, SQL, Python®, Javascript®, and C#®.

In another embodiment other platforms and languages may be used to build such a website.

A number of filters and pre-solving methods can be used to improve the time complexity of the computerized process.

Some filtering techniques, but not limited to, that could be used are as follows:

(1) If number of roomGroup requests is greater than number of available roomlets;
(2) Calculate the biggest combinable areas and check to see if the minimum area of biggest room parameter will be satisfied based on this;
(3) Take the sum of the minimum combined room area of each roomGroup and check to see if the venue has enough total area;
(4) Find the biggest combinable areas in the venue. For the latest request, order the largest n biggest combinable areas and check to see if their sum is greater than or equal to the minimum area that is requested by the organizer. If yes, proceed, if no, filter; and
(5) Starting from the outside exterior access, create a Maximum Leaf Spanning Tree (“MLST”) with the maximal leaf nodes. This is the maximum number of Groups possible to be accommodated in that structure.

The above filtering methods are being listed for clarity and may not represent all filtering methods possible. One skilled in the art would be able to understand and formulate other related filters to improve the time complexity of the computerized process.

Some, but not all, pre-solving methods that could be used are as follows:

Create a Max Leaf Spanning Tree leading to a reservation state change of some roomlets to blocked for the purpose of the computerized process as said roomlets must remain unoccupied to fit the number of current number of Group requests while allowing feasible pathways to the exterior access for each of the Groups.

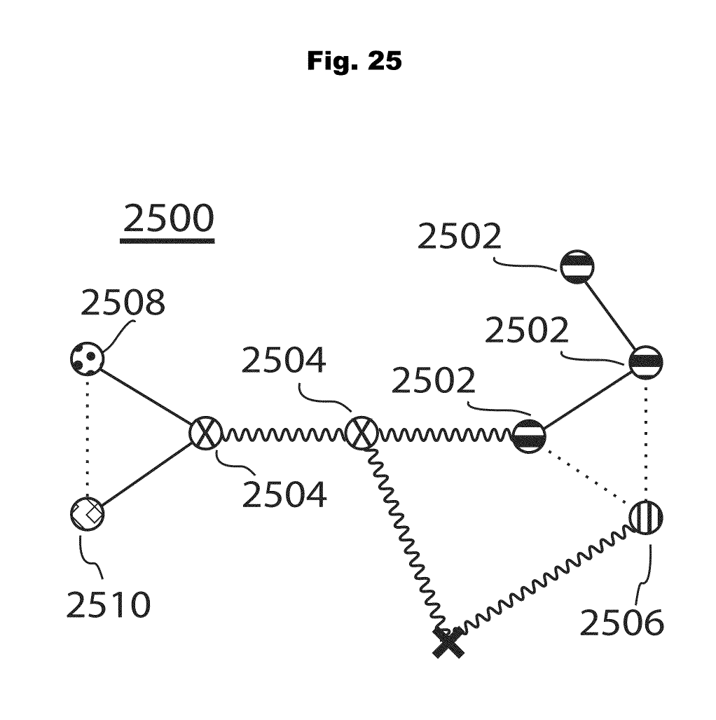

FIG. 25 shows an exemplary region adjacency graph (2500) illustrating the above pre-solving function. There are multiple Groups or Group requests (2510, 2508, 2506, 2502). The maximum leaf spanning tree is used to identify how many maximum groups can fit in the structure, in this case region adjacency graph. In the specific exemplary case of the provided region adjacency graph with four groups, certain roomlets must always be unoccupied and therefore set to blocked (2504) to fit those four Groups. In other region adjacency graphs, given a certain number of GroupRequests, specific roomlets may be set to blocked.

The above pre-solving method is being listed for clarity. Other pre-solving methods may exist. One skilled in the art would be able to understand and formulate other related pre-solving methods to improve the time complexity of the computerized process.

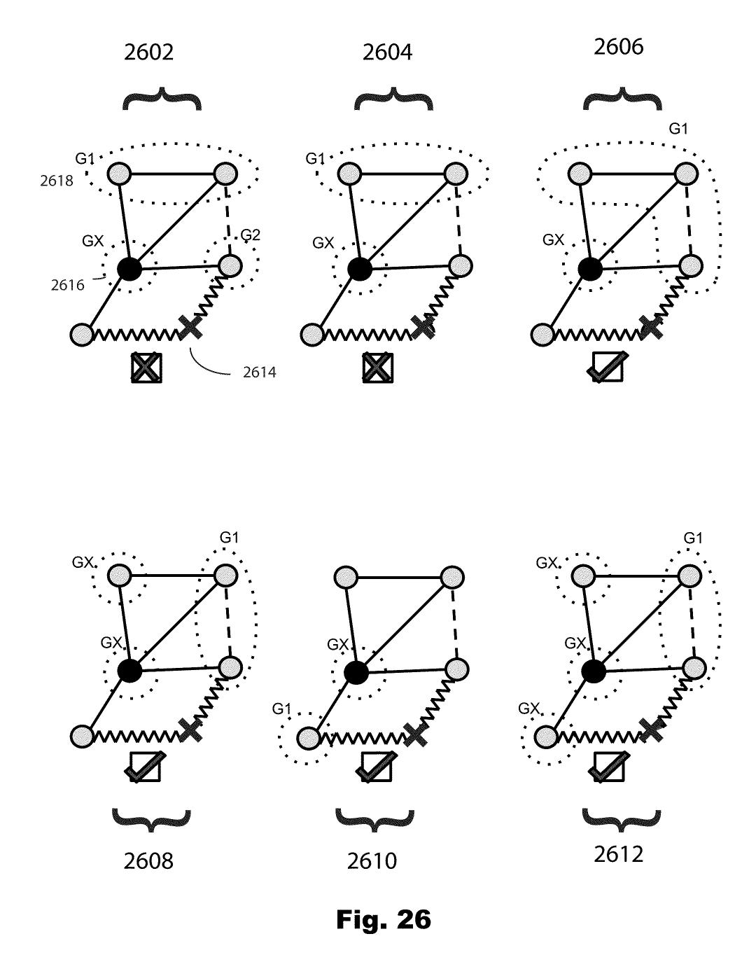

FIG. 26 has various region adjacency graphs shown through (2602, 2604, 2606, 2608, 2610, 2612). Valid configurations are shown in (2606, 2608, 2610, 2612). Invalid configurations are shown in (2602, 2604). In graph (2602) an assigned roomlet is shown through (2616), meaning that a Group already has been allocated that roomlet, and a new roomGroup request is shown through (2618) with the exterior access being shown through (2614). roomGroup (2618) has no feasible pathway to the exterior access, and therefore the configuration is invalid in RAG (2602).

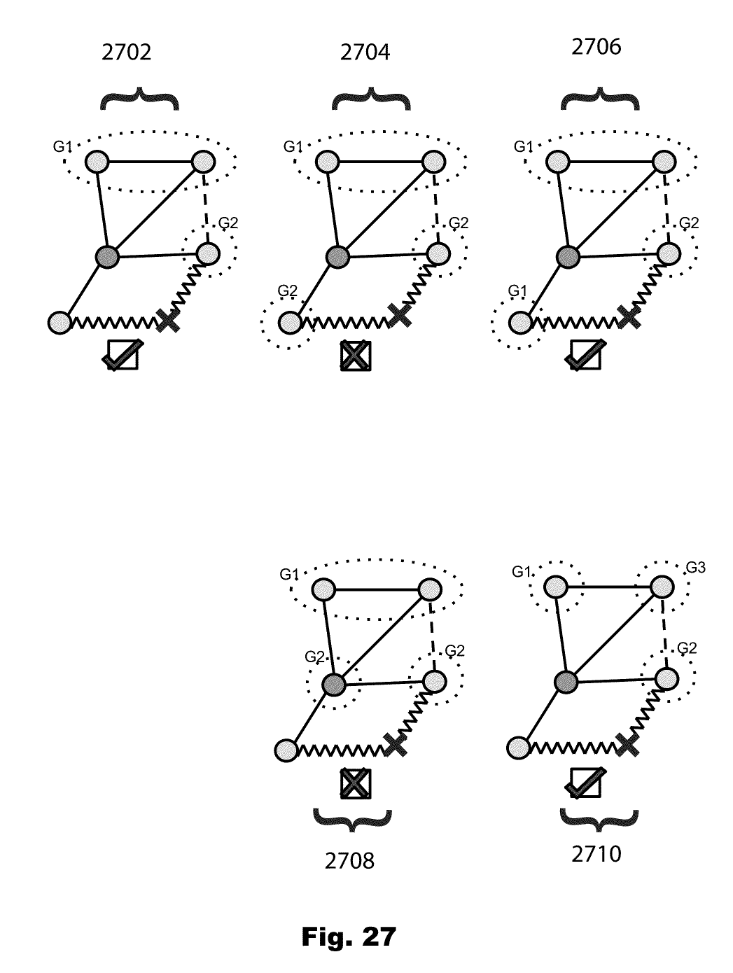

FIG. 27 shows various region adjacency graphs (2702, 2704, 2706, 2708, 2710). Valid configurations are shown through (2702, 2706, 2710). Invalid configurations are shown through (2704, 2708). The grey nodes are used to represent unassigned blocking, meaning blocking of a roomlet designated to no group. The case (2708) has been used to indicate that a group cannot be allocated to an unassigned blocking space because it prevents G1 from having a feasible pathway to the exterior access.

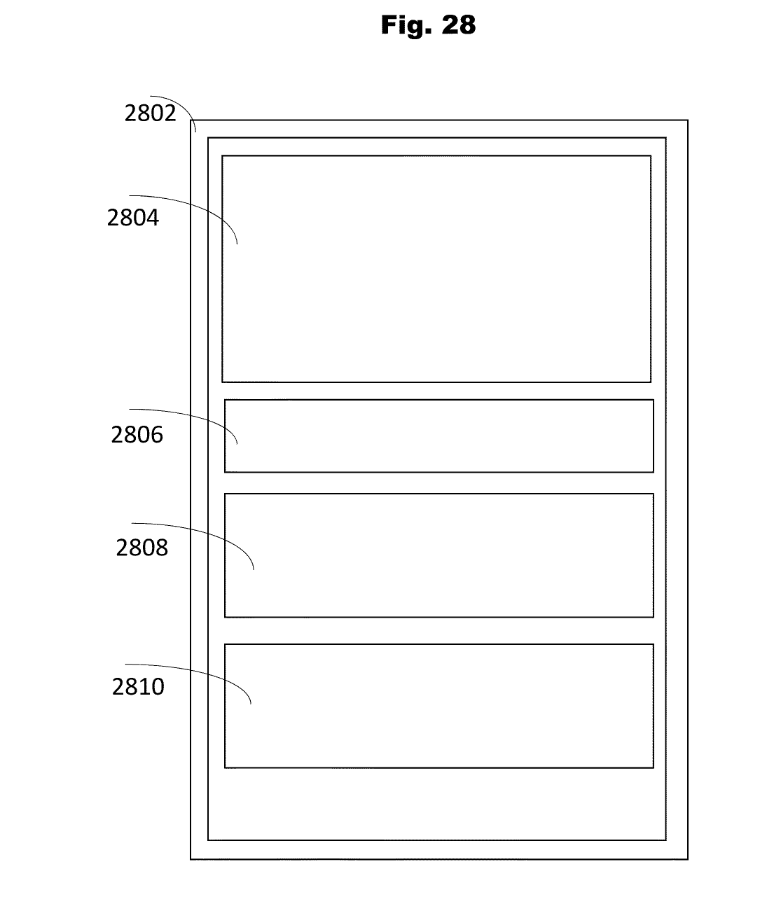

FIG. 28 shows an exemplary report generated after the selection of roomlets for an event for an organizer. (2802) indicates a computer or tablet screen. (2804) indicates organizer and venue related details. (2806) represents the roomlet names, timings, and booking details. (2808) represents any special information such as that Airwalls must be open, etc. (2810) represents an electronic signature between both the venue and organizer parties.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood terms by one of ordinary skill in the art to which the disclosure pertains.

What is claimed is:

1. A method for configuring a space within a venue for an event for an organizer via a computerized process, said method comprising:
entering a data describing the space into a computer system;
transforming, by the computer system, the data into a simplified data structure;
gathering requirements for a group within the space into the computer system;
matching, by the computer system, the requirements to roomlets within the venue;
selecting, by the computer system, a set of roomlets to assign to the group that both match the requirements and provide at least one feasible pathway to at least one exterior access;
changing the reservation state of the set of roomlets based on the selecting; and
generating, by the computer system, a report of the selecting.

2. The method of claim 1, further comprising computing sound levels into and out of the roomlets and taking the sound levels into account in the selecting.

3. The method of claim 2, wherein the computing sound levels includes computing a simplified data structure of the roomlets, said simplified data structure including sound characteristics.

4. The method of claim 1, further comprising changing a selection of a roomlet based on the reservation state of the roomlet and an occurrence of a second booking.

5. The method of claim 1, further comprising maintaining the reservation state of the selected set of roomlets to the group despite a second booking.

6. The method of claim 1, wherein the selecting further includes considering an airwall between adjoining ones of the roomlets.

7. The method of claim 6, wherein the selecting further includes considering a presence of an access through the airwall.

8. The method of claim 7, wherein an airwall that does not extend across an entire roomlet is considered an airwall with an access.

9. The method of claim 1, further comprising adjusting at least one physical characteristic of one or more of the roomlets of the group based on the requirements.

10. The method of claim 9, wherein the adjusting includes configuring airwalls between the roomlets based on the report.

11. The method of claim 9, where in the adjusting includes sending a command to an automated system located in the venue and connected to roomlets within the space, said automated system being configured to perform the adjusting in an automated fashion.

12. The method of claim 1, wherein the selecting further includes reducing a total cost to the organizer based on rental prices of the roomlets and wherein the report includes the total cost.

13. The method of claim 12, wherein the total cost to the organizer is based on a reservation state of at least one of the roomlets.

14. The method of claim 1, wherein the space comprises multiple venues.

15. The method of claim 1, further comprising iterating the method for bookings wherein the selecting includes considering more than one unit of time.

16. The method of claim 1, wherein the feasible paths include pathways between floors.

17. The method of claim 1, wherein the requirements are provided by the organizer, the computer system is provided by a provider, and the roomlets are provided by the venue, and the organizer, provider, and venue are three separate entities.

18. The method of claim 17, wherein the organizer utilizes a mobile computing or communication device to connect to the provider.

19. The method of claim 1, wherein the simplified data structure includes a region adjacency matrix.

20. The method of claim 1, further comprising matching the requirements to roomlets of spaces from multiple venues.

21. The method of claim 1, wherein the group is divided into roomgroups of contiguous roomlets.

22. The method of claim 21, wherein the selecting further includes ensuring that the roomgroups each have a concavity that is acceptable according to the requirements.

23. The method of claim 1, further comprising sending select data to a display device at the venue, said display device being normally visible to attendees of the event.

24. A system configured to perform the method of claim 1.

25. A computer readable non-transitory medium encoded with data configured to enable a computer to perform the method of claim 1.

26. The method of claim 1, further comprising sharing booking data with another computer system.

27. The method of claim 26, wherein the another computer system is a hotel registry system.

28. The method of claim 1, further comprising:
gathering sound data regarding the roomlets within the space including sound transmission of boundaries of each roomlet of the roomlets;
creating a sound transmission graph from said sound data; and
gathering sound requirements from the organizer;
wherein said matching further includes matching the sound requirements with the sound transmission graph.

29. A method for configuring a space within a venue via a computerized process, said method comprising:
establishing a roomlet within the space as having a reservation state of free for use;
for a first tier of booking:
if the roomlet is assigned to an organizer, changing the reservation state from free for use to tentatively booked;
if the roomlet is confirmed to the organizer, changing the reservation state from tentatively booked to confirmed;
for a second tier of booking, if the roomlet is assigned to the organizer, changing the reservation state from free for use to confirmed; and
for either tier of booking, changing the reservation state of the roomlet to blocked if assignment of said roomlet would prevent any viable pathway to an exterior access from existing;
wherein the reservation state can return to free for use from tentatively booked at any time, but cannot return to free from use from confirmed until after the roomlet is used or until a cancellation of a reservation to the venue.

30. The method of claim 1, further comprising a pre-solution method performed prior to the matching and the selecting, the pre-solution method being configured to reduce a number of configurations used by the matching and the selecting.

31. The method of claim 20, further comprising pre-filtering the requirements to determine if the venue can accommodate said requirements.

32. A method for configuring space within a venue for a plurality of events for corresponding organizers via a computerized process, said method comprising:
entering a data describing the space into a computer system;
transforming, by the computer system, the data into a simplified data structure;
gathering requirements for groups corresponding to the organizers into the computer system;
matching, by the computer system, the requirements to roomlets within the space;
selecting for each organizer, by the computer system, sets of the roomlets within the venue to assign to each group that matches the requirements and provides at least one feasible pathway to at least one exterior access;
changing the reservation states of the sets of the roomlets based on the selecting;
gathering new requirements for a new group corresponding to a new organizer into the computers system;
re-matching, by the computer system, the new requirements to the roomlets within the space;
re-selecting, by the computer system, a set of the roomlets that matches the new requirements and provides at least one feasible pathway to at least one exterior access;
changing at least one of the reservation states of the sets of the roomlets and changing the reservation states of the set of the roomlets based on the re-selecting; and
generating, by the computer system, a report of the re-selecting.

33. The method of claim 32, wherein the new organizer is one of said organizers, said one of said organizers having changed requirements.
